(19) United States
(12) Patent Application Publication
(10) Pub. No.: US 2021/0316538 A1
(43) Pub. Date: Oct. 14, 2021

(54) ECO-FRIENDLY CONTAINER LABEL AND METHOD OF MANUFACTURING ECO-FRIENDLY CONTAINER

(71) Applicant: DONGWON SYSTEMS CORPORATION, Seongnam-si (KR)

(72) Inventors: Sung Ji Choi, Ansan-si (KR); Jin Seok Choi, Pyeongtaek-si (KR)

(73) Assignee: DONGWON SYSTEMS CORPORATION, Seongnam-si (KR)

(21) Appl. No.: 17/191,881

(22) Filed: Mar. 4, 2021

(30) Foreign Application Priority Data
Apr. 10, 2020 (KR) 10-2020-0043865

(51) Int. Cl. B32B 27/08; B32B 7/12; B32B 27/32; B32B 27/16; B32B 37/24; B65D 65/40; B29C 45/16

(52) U.S. Cl. CPC B32B 27/08; B29L 2031/712; B32B 27/32; B32B 27/16; B32B 37/24; B65D 65/40; B29C 45/1679; B32B 2307/75; B32B 2519/00; B32B 2255/10; B32B 2255/26; B32B 2307/7244; B32B 2307/7246; B32B 2439/70; B32B 2037/243; B32B 7/12

(57) ABSTRACT

Disclosed are an eco-friendly container label and a method of manufacturing an eco-friendly container. The eco-friendly container label to be attached to a disposable container includes a first layer including a print layer, and a barrier layer stacked on one side of the print layer, a second layer including an adhesive layer formed of the same material as the print layer, the adhesive layer to be stacked on the surface of the disposable container, and an intermediate base layer stacked between the first layer and the second layer and configured to bond the adhesive layer and the print layer.

### CROSS-REFERENCE TO RELATED APPLICATION(S)

This application claims the benefit of Korean Patent Application No. 10-2020-0043865, filed on Apr. 10, 2020, in the Korean Intellectual Property Office, the disclosure of which is incorporated herein by reference.

### BACKGROUND

### 1. Field of the Invention

One or more example embodiments relate to an eco-friendly container label that is easy to recycle and a method of manufacturing an eco-friendly container.

### 2. Description of the Related Art

With the recently increasing use of ready to drink (RD) containers for cups, recycling of disposable containers that are discarded after drinking has emerged as an important issue in the protection of the environment.

Conventional labels were made of aluminum foil or aluminum-deposited PET for moisture and oxygen barrier power. However, these materials were difficult to recycle due to the mixed use with other materials constituting labels.

For example, in the case of a conventional label made of PET, aluminum, and PP mixed together, it was difficult to separate the label from a container that is made of other materials and difficult to reuse and recycle the label itself made of different materials.

Therefore, there is a demand for developing an eco-friendly label made of a single material so as to facilitate recycling while securing oxygen and moisture barrier power.

The above description has been possessed or acquired by the inventor(s) in the course of conceiving the present invention and is not necessarily an art publicly known before the present application is filed.

### SUMMARY

An aspect provides an eco-friendly container label that is easy to recycle while having oxygen and moisture barrier power and a method of manufacturing an eco-friendly container.

Another aspect also provides an eco-friendly container label that is formed of a single material so as to be recycled and a method of manufacturing an eco-friendly container.

According to an aspect, there is provided an eco-friendly container label to be attached to a disposable container, the eco-friendly container label including a first layer including a print layer, and a barrier layer stacked on one side of the print layer, a second layer including an adhesive layer formed of the same material as the print layer, the adhesive layer to be stacked on the surface of the disposable container, and an intermediate base layer stacked between the first layer and the second layer and configured to bond the adhesive layer and the print layer.

The eco-friendly container label may include the same material as the disposable container and be attached to the surface of the disposable container in an in-mold manner.

The disposable container may be formed of polypropylene (PP), the print layer may be formed of oriented polypropylene (OPP), and the adhesive layer may be formed of PP.

The intermediate base layer may be corona-treated on the surface thereof and formed of PP.

The barrier layer may be formed by coating the surface of the print layer with at least one of polyurethane dispersion (PUD) and polyvinyl alcohol (PVA).

The barrier layer may be formed by depositing AlOx on the surface of the print layer.

The barrier layer may have gas barrier properties of 0.1 to 1.0 cc/[m2-day] and have moisture barrier properties of 0.5 to 2.0 g/[m2-day].

According to another aspect, there is provided a method of manufacturing an eco-friendly container, the method including manufacturing an eco-friendly container label formed of polypropylene (PP), placing the eco-friendly container label on an inner wall of a container mold, attaching the eco-friendly container label to the outer surface of a container in an in-mold manner, through injection molding of the container after injecting a plastic material of PP into the container mold, and cooling the container mold and withdrawing an eco-friendly container.

The manufacturing may include forming a first layer by coating the surface of a print layer formed of oriented polypropylene (OPP) with a barrier layer, laminating an intermediate base layer that is formed of PP and corona-treated on the surface thereof on the first layer, by attaching one side of the intermediate base layer in a direction opposite to the winding direction of the first layer, and laminating an adhesive layer formed of PP on the other side of the intermediate base layer.

The barrier layer may be formed by coating the surface of the print layer with at least one of polyurethane dispersion (PUD) and polyvinyl alcohol (PVA), or by depositing AlOx on the surface of the print layer, and the barrier layer may have gas permeability of 0.1 to 1.0 cc/[m2-day] and have moisture barrier properties of 0.5 to 2.0 g/[m2-day].

Additional aspects of example embodiments will be set forth in part in the description which follows and, in part, will be apparent from the description, or may be learned by practice of the disclosure.

### BRIEF DESCRIPTION OF THE DRAWINGS

The accompanying drawings illustrate preferred example embodiments of the present invention, and are provided together with the detailed description for better understanding of the technical idea of the present invention. Therefore, the present invention should not be construed as being limited to the example embodiments set forth in the drawings.

FIG. 1 is a perspective view illustrating an eco-friendly container according to an example embodiment.

FIG. 2 is a perspective view illustrating an eco-friendly container label according to an example embodiment.

FIG. 3 is a cross-sectional view illustrating an eco-friendly container label according to an example embodiment.

FIG. 4 is a flowchart illustrating a method of manufacturing an eco-friendly container according to an example embodiment.

FIG. 5 is a flowchart illustrating an operation of manufacturing an eco-friendly container label according to an example embodiment.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The same name may be used to describe an element included in the example embodiments described above and an element having a common function. Unless otherwise mentioned, the descriptions on the example embodiments may be applicable to the following example embodiments and thus, duplicated descriptions will be omitted for conciseness.

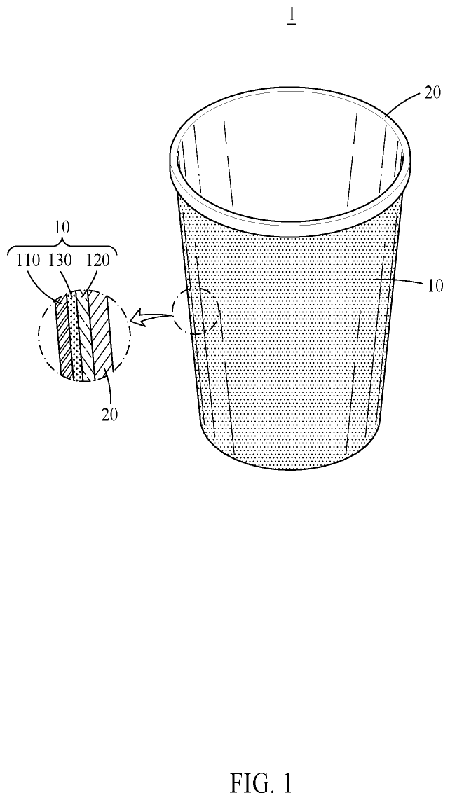

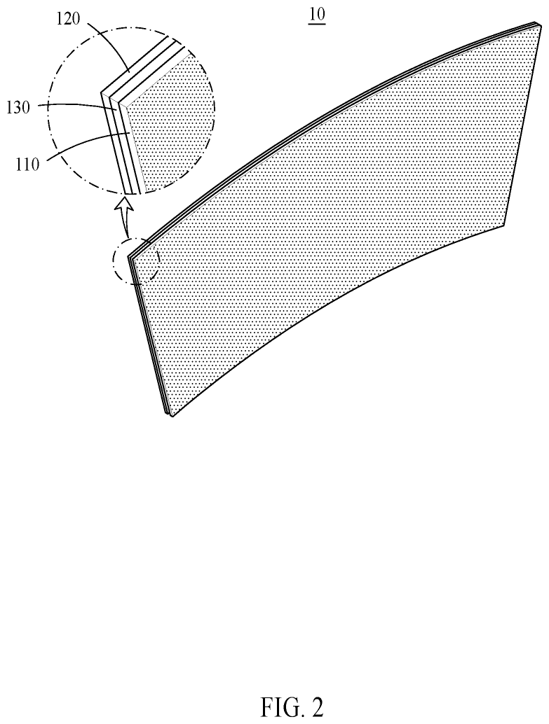

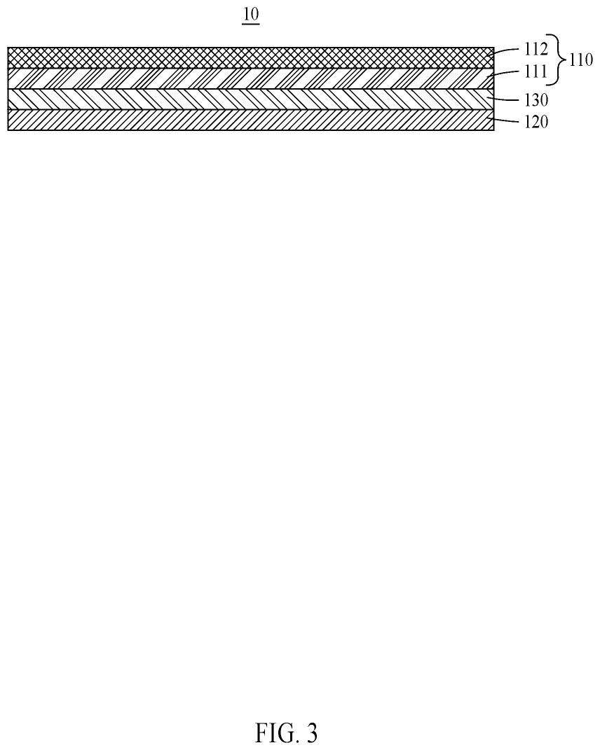

FIG. 1 is a perspective view illustrating an eco-friendly container according to an example embodiment, FIG. 2 is a perspective view illustrating an eco-friendly container label according to an example embodiment, and FIG. 3 is a cross-sectional view illustrating the eco-friendly container label according to an example embodiment.

Referring to FIGS. 1 to 3, an eco-friendly container 1 may be used to store food, for example, beverages. The eco-friendly container 1 may include a container body 20, and an eco-friendly container label 10 attached to the outer surface of the container body 20.

The container body 20 may include an accommodation space to accommodate a beverage therein. The container body 20 may be provided in the form of, for example, a tumbler. The container may include a flat base, and a cylindrical side extending upwardly from the base. The container body 20 may be formed of a disposable material, for example, polypropylene (PP).

The eco-friendly container label 10 may be formed of the same material as the container body 20. For example, the eco-friendly container label 10 may be formed of the same material as the container body 20 to which it is attached, that is, polypropylene. When the container body 20 and the container label 10 are formed of the same material, it is not necessary to separate the used container into different materials. Thus, recycling may be performed more easily.

The eco-friendly container label 10 may be attached to the container body 20 during the process of manufacturing the container body 20. For example, the eco-friendly container label 10 may be attached to the outer wall of the container body 20 in an in-mold manner during the injection molding process of the container body 20.

The eco-friendly container label 10 may be formed by stacking multiple layers. In this case, the layers constituting the eco-friendly container label 10 may be formed of the same material as the container body 20, for example, polypropylene. The eco-friendly container label 10 may include a first layer 110 including a print layer 111 on which information of an item is printed, a second layer 120 stacked on the container surface, and an intermediate base layer 130 configured to bond the first layer 110 and the second layer 120.

The first layer 110 may include the print layer 111, and a barrier layer 112 stacked on the surface of the print layer 111.

The print layer 111 refers to a film layer positioned outside when the eco-friendly container label 10 is attached to the container body 20. Information on the contents of the eco-friendly container 1 may be printed on the print layer 111. The print layer 111 may be formed of a transparent material so that printed information may be recognized outside. In this case, the material of the print layer 111 may be the same as that of the container body 20, for example, at least one of oriented polypropylene (OPP) or cast polypropylene (CPP).

The barrier layer 112 may be formed on the surface of the print layer 111. The barrier layer 112 may function as a barrier to protect the contents in the container body 20 by blocking gas and moisture coming from the outside. The barrier layer 112 may be formed by coating the surface of the print layer 111 with polyurethane dispersion (PUD) or polyvinyl alcohol (PVA). Alternatively, the barrier layer 112 may be formed by depositing aluminum oxide (AlOx) on the surface of the print layer 111. A conventional container label was made of aluminum to prevent decay of contents, whereas the container label according to an example embodiment may block gas and moisture through the barrier layer 112 formed on the surface of the print layer 111 by coating or deposition. Thus, the eco-friendly container 1 itself may be recycled even without a separate process of separating aluminum during the disposal process after use, whereby eco-friendly effects may be secured.

The second layer 120 may include an adhesive layer stacked on the surface of the container body 20.

The adhesive layer refers to a film layer that contacts the outer wall of the container body 20 during the injection molding process of the container body 20. The adhesive layer may be formed of the same material as the container body 20, for example, polypropylene (PP).

The intermediate base layer 130 may be stacked between the first layer 110 and the second layer 120 to bond the first layer 110 and the second layer 120. As the first layer 110 and the second layer 120 are bonded to each other by the intermediate base layer 130, a container label of a three-layer structure may be formed.

The intermediate base layer 130 may also be formed of the same material as the container body 20, for example, polypropylene (PP). In this case, the intermediate base layer 130 may be corona-treated on its surface, so that both surfaces thereof may be attached to the first layer 110 and the second layer 120, respectively.

According to this structure, the eco-friendly container label 10 is formed in a structure in which multiple functional layers formed of the same material as the container body 20, that is, polypropylene, are stacked. Therefore, the eco-friendly container 1 may be easy to recycle during the disposal process after use.

In particular, the eco-friendly container label 10 does not use a material different from that of the container body 20, for example, an aluminum thin film, for barrier function to protect contents, but performs a barrier function through the barrier layer 112 applied to the print layer 111 by coating. In this case, the barrier layer 112 has gas permeability of 0.1 to 1.0 cc/[m2-day] and moisture barrier properties of 0.5 to 2.0 g/[m2-day], whereby the container label may secure a sufficient level of barrier efficiency.

The eco-friendly container label 10 is attached to the outer surface of the container body 20 in an in-mold manner during the injection molding process of the container body 20. Since the eco-friendly container label 10 is formed of the same material as the container body 20, the process of separating each layer may be omitted.

Hereinafter, a method of manufacturing an eco-friendly container will be described. When describing the method of manufacturing an eco-friendly container, a duplicate description will be omitted for conciseness.

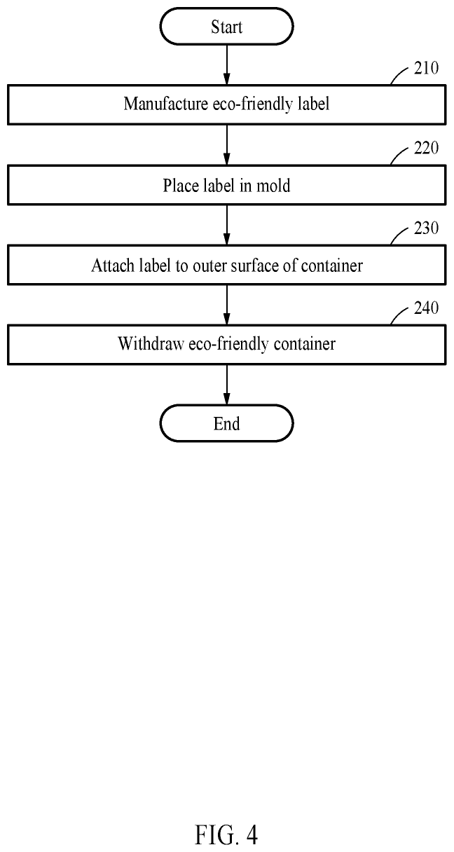

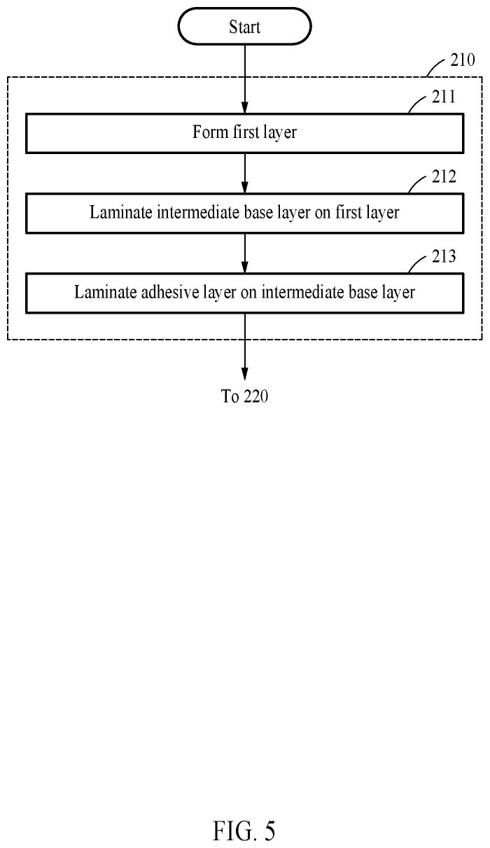

FIG. 4 is a flowchart illustrating a method of manufacturing an eco-friendly container according to an example embodiment, and FIG. 5 is a flowchart illustrating an operation of manufacturing an eco-friendly container label according to an example embodiment.

Referring to FIGS. 4 and 5, a method of manufacturing an eco-friendly container may include operation 210 of manufacturing an eco-friendly container label, operation 220 of placing the eco-friendly container label in a container mold, operation 230 of attaching the eco-friendly container label to the outer surface of a container during the injection molding process of the container, and operation 240 of withdrawing an eco-friendly container from the mold.

In operation 210, an eco-friendly container label may be manufactured. Operation 210 may include operation 211 of forming a first layer, operation 212 of laminating an intermediate base layer on the first layer, and operation 213 of laminating an adhesive layer on the intermediate base layer.

In operation 211, a first layer may be formed by forming a barrier layer on the surface of a print layer. The print layer may be formed of OPP. The barrier layer may be formed by coating the surface of the print layer with polyurethane dispersion (PUD) or polyvinyl alcohol (PVA) or by depositing AlOx on the surface of the print layer. In this case, the barrier layer may have gas barrier properties of 0.1 to 1.0 cc/[m2-day] and moisture barrier properties of 0.5 to 2.0 g/[m2-day].

In operation 212, an intermediate base layer may be attached to and laminated on the first layer. The intermediate base layer may be formed of polypropylene. In this case, the intermediate base layer is corona-treated on its surface, and one surface of the intermediate base layer may be laminated on the first layer by attaching thereto in a direction opposite to the winding direction of the first layer. In this way, the curling occurring during the laminating process may be reduced to 0.1 to 7.0 mm, enabling stable feeding during the injection molding process of the container.

In operation 213, an adhesive layer formed of polypropylene may be laminated on the other side of the intermediate base layer.

In operation 220, the manufactured eco-friendly container label may be placed in a container mold. The container mold is designed for injection molding of a disposable container and may be manufactured in a shape corresponding to the shape of the container. The eco-friendly container label may be placed on the inner wall of the container mold.

In operation 230, a disposable container may be manufactured through injection molding by injecting a container material into the container mold. In this case, the material of the container may be polypropylene. During the injection molding process of the container, an adhesive part of the eco-friendly container label may be attached to the outer surface of the produced container in an in-mold manner.

In operation 240, an eco-friendly container may be withdrawn from the mold. In this case, the eco-friendly container may be easily recycled without being separated into different materials during the disposal process after use since a container body and a label attached to the outer surface of the container body are formed of the same material, for example, a polypropylene-based material.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

What is claimed is:

1. An eco-friendly container label to be attached to a disposable container, the eco-friendly container label comprising:
a first layer comprising a print layer, and a barrier layer stacked on one side of the print layer;
a second layer comprising an adhesive layer formed of the same material as the print layer, the adhesive layer to be stacked on the surface of the disposable container; and
an intermediate base layer stacked between the first layer and the second layer and configured to bond the adhesive layer and the print layer.

2. The eco-friendly container label of claim 1, wherein the eco-friendly container label includes the same material as the disposable container and is attached to the surface of the disposable container in an in-mold manner.

3. The eco-friendly container label of claim 2, wherein the disposable container is formed of polypropylene (PP),
the print layer is formed of oriented polypropylene (OPP), and
the adhesive layer is formed of PP.

4. The eco-friendly container label of claim 3, wherein the intermediate base layer is corona-treated on the surface thereof and formed of PP.

5. The eco-friendly container label of claim 3, wherein the barrier layer is formed by coating the surface of the print layer with at least one of polyurethane dispersion (PUD) and polyvinyl alcohol (PVA).

6. The eco-friendly container label of claim 3, wherein the barrier layer is formed by depositing AlOₓ on the surface of the print layer.

7. The eco-friendly container label of claim 5, wherein the barrier layer has gas barrier properties of 0.1 to 1.0 cc/[m²-day] and has moisture barrier properties of 0.5 to 2.0 g/[m²-day].

8. A method of manufacturing an eco-friendly container, the method comprising:
manufacturing an eco-friendly container label formed of polypropylene (PP);
placing the eco-friendly container label on an inner wall of a container mold;
attaching the eco-friendly container label to the outer surface of a container in an in-mold manner, through injection molding of the container after injecting a plastic material of PP into the container mold; and
cooling the container mold and withdrawing an eco-friendly container.

9. The method of claim 8, wherein the manufacturing comprises:
forming a first layer by coating the surface of a print layer formed of oriented polypropylene (OPP) with a barrier layer;
laminating an intermediate base layer that is formed of PP and corona-treated on the surface thereof on the first layer, by attaching one side of the intermediate base layer in a direction opposite to the winding direction of the first layer; and
laminating an adhesive layer formed of PP on the other side of the intermediate base layer.

10. The method of claim 9, wherein the barrier layer is formed by coating the surface of the print layer with at least one of polyurethane dispersion (PUD) and polyvinyl alcohol (PVA), or by depositing AlOₓ on the surface of the print layer, and
the barrier layer has gas permeability of 0.1 to 1.0 cc/[m²-day] and has moisture barrier properties of 0.5 to 2.0 g/[m²-day].
